(19) United States
(12) Patent Application Publication
(10) Pub. No.: US 2010/0136347 A1
(43) Pub. Date: Jun. 3, 2010

(54) TWO COMPONENT SOLVENTLESS POLYURETHANE LAMINATING ADHESIVES BASED ON 1,4:3,6 DIANHYDROHEXITOLS

(76) Inventors: J. Brandon Simons Simons, Raleigh, NC (US); Balasubramaniam Ramalingam, Cary, NC (US); Eugene G. Sommerfeld, Danvers, MA (US)

Correspondence Address: Loctite Corporation, One Henkel Way, Rocky Hill, CT, 06067, US

(21) Appl. No.: 12/374,937

(22) PCT Filed: Jul. 17, 2007
(86) PCT No.: PCT/US07/73646

§ 371 Date: Jan. 11, 2010

Related U.S. Application Data
(60) Provisional application No. 60/835,933, filed on Aug. 7, 2006.

(51) Int. Cl. C08G 18/28; C08G 18/10; B32B 15/08; B32B 27/40; B32B 27/08; C09J 175/04

(52) U.S. Cl. 428/423.7; 528/85; 528/80; 528/60; 428/423.1; 428/425.8; 156/328

(57) ABSTRACT

A two component laminating adhesive is provided, wherein one component contains at least one isocyanate-functionalized compound and the other component contains one or more 1,4:3,6 dianhydrohexitols. A laminate may be formed by combining the two components to provide an adhesive and then using the adhesive to adhere one polymeric film or metallic foil to another polymeric film or metallic foil. The adhesive layer between the film and/or foil layers of the laminate is then cured. The adhesives exhibit faster green strength development and higher final bond strength as compared to conventional two component laminating adhesives not containing any 1,4:3,6 dianhydrohexitol as a coreactant.

### FIELD OF THE INVENTION

The present invention provides two component laminating adhesives based on polyurethanes in which one of the components contains a 1,4:3,6 dianhydrohexitol such as isosorbide and the other component contains an isocyanate-functionalized compound such as an isocyanate-functionalized polyurethane prepolymer. The laminating adhesives are useful for laminating thin polymeric films and/or foils to each other, with the resulting flexible laminates being highly suitable for the fabrication of food packaging and the like.

### DISCUSSION OF THE RELATED ART

Laminating adhesives are widely used in the manufacture of film/film and film/foil laminates, including multilayer laminates. Solventless adhesives (adhesives that can be applied at 100% solids without either organic solvents or water) have a distinct advantage in such applications in that they can be applied and run at very high line speeds. This is due to the fact that no organic solvent or water has to be dried from the adhesive. The use of solvent or water-based adhesives is limited by an application speed that is determined by the rate at which the solvent or water can be effectively dried and removed in an oven.

Typical line speeds for solvent-base and water-based adhesives are 300 to 600 feet per minute due to the drying restrictions. Solventless adhesives, on the other hand, can be applied at 900 to even 1500 feet per minute. This offers a distinct advantage over solvent-based or water-borne laminating adhesives.

Among many known solventless systems, the use of polyurethane based laminating adhesives is preferred because of their many desirable properties including good adhesion, peel strength, heat seal strength and resistance to aggressive filling goods. Typically, an isocyanate-containing polyurethane prepolymer obtained by the reaction of excess diisocyanate with a polyether and/or polyester containing two or more active hydrogen groups per molecule is used in combination with a second component. The second component usually is a polyether and/or polyester functionalized with two or more hydroxyl groups or the like per molecule. The two components are combined in a predetermined ratio and applied on one of the film or foil substrates, which is then laminated to the second substrate.

Inherent weaknesses of two component solventless laminating adhesives as compared to traditional one or two component solvent-containing adhesives include low initial bonds and slow bond development before the laminate can be processed. This extra time in the laminate processor's plant ties up space and requires extra capital for inventory while the laminate is curing. It would therefore be desirable to develop solventless laminating adhesives that exhibit faster bond development and higher bond strength than conventional adhesives of this type.

### SUMMARY OF THE INVENTION

The present invention provides a two component laminating adhesive comprising Component A and Component B, wherein Component A comprises at least one isocyanate-functionalized compound and Component B comprises one or more 1,4:3,6 dianhydrohexitols. A laminate may be formed by combining the two components to provide an adhesive and then using the adhesive to adhere one polymeric film or metallic foil to another polymeric film or metallic foil. The adhesive layer between the film and/or foil layers of the laminate is then cured.

### DETAILED DESCRIPTION OF CERTAIN EMBODIMENTS OF THE INVENTION

Component B of the two component laminating adhesives of the present invention is comprised of one or more 1,4:3,6 dianhydrohexitols, which are the 1,4:3,6 dianhydrides of the sugar alcohols mannitol, sorbitol and iditol. Such compounds are bicyclic compounds wherein each cyclic ring in the molecule contains four carbon atoms and one oxygen atom, with one carbon atom in each ring being substituted with a hydroxyl (—OH) group.

The three dianhydrohexitol isomers have the common names isomannide, isosorbide and isodide. For purposes of the present invention, isosorbide is preferred and in desirable embodiments is employed as the sole 1,4:3,6 dianhydrohexitol in Component B, although Component B could alternatively contain isosorbide in combination with one or both of isomannide or isodide. The 1,4:3,6 dianhydrohexitols may be prepared by any of the methods known in the art, including the acid-catalyzed dehydration and cyclization of the parent sugar alcohol. The use of such substances in two component laminating adhesives thus is advantageous since they can be prepared from natural, renewable resources instead of petrochemicals, which can provide economic as well as environmental benefits. A suitable process for manufacturing 1,4:3,6 dianhydrohexitols is described, for example, in U.S. Pat. No. 6,864,378, incorporated herein by reference in its entirety. Isosorbide can also be obtained from commercial sources such as Roquette Freres (Lestrem, France).

The amount of 1,4:3,6 dianhydrohexitol in Component B may be varied as desired in order to impart certain preselected properties and characteristics to the resulting laminating adhesive prepared from Component B. For example, from about 0.1 up to 100 weight percent of Component B may be comprised of one or more 1,4:3,6 dianhydrohexitols. Other isocyanate-reactive substances, such as those described in more detail below as well as other isocyanate-reactive substances known or conventionally used in two component laminating adhesives, may also be present in Component B, if so desired. For example, it will generally be desirable to utilize one or more 1,4:3,6 dianhydrohexitols in combination with one or more polymeric polyols such as a polyether polyol, polyester polyol, or polyether ester polyol (preferably having a number average molecular weight of from about 250 to about 4500 or from about 500 to about 1500 and/or a viscosity at 25 degrees C. of from about 200 cps to about 5000 cps). Polymeric polyols suitable for such purpose are well known in the art and are also described in more detail hereinafter in connection with the preparation of isocyanate-functionalized polyurethane prepolymers for use in Component A of the present invention. In such embodiments, the 1,4:3,6 dianhydrohexitols function as chain extenders in the polyurethane formed by reaction of Component A and Component B while the polymeric polyols impart flexibility to the cured adhesive. In one embodiment of the invention, 1,4:3,6 dianhydrohexitol comprises at least about 3 weight percent of Component B (e.g., from about 5 to about 50 weight percent or from about 8 to about 35 weight percent of Component B). In another embodiment, the alcohol groups of 1,4:3,6 dianhydrohexitol portion of Component B comprise at least about 10 mole % of the active hydrogen groups in Component B (e.g., from about 20 to about 75 mole % or from about 30 to about 65 mole % of the active hydrogen groups in Component B). The solubility and melting point of the 1,4:3,6 dianhydrohexitol employed may also need to be taken into account when selecting the composition of Component B. For example, it may be advantageous to formulate Component B such that it remains a homogeneous, relatively low viscosity liquid at the temperatures encountered during processing and handling. Generally speaking, the use of relatively polar, liquid (at room temperature) coreactant(s) in Component B will enable higher concentrations of the 1,4:3,6 dianhydrohexitol(s) to be maintained in Component B without resolidification of the 1,4:3,6 dianhydrohexitol.

Calculated on the basis of the total weight of the laminating adhesive, the 1,4:3,6 dianhydrohexitol typically represents at least about 0.5 weight percent of the laminating adhesive (e.g., from about 0.5 to about 25 weight percent or from about 1 to about 15 weight percent).

Isocyanate-reactive substances which can be used in combination with one or more 1,4:3,6 dianhydrohexitols in Component B of the present invention generally include those compounds which are active hydrogen-functionalized. “Active hydrogen-functionalized” as used herein refers to a functional group containing a hydrogen atom which, because of its position in the compound, displays significant activity according to the Zerewitnoff test described by Wohler in the Journal of the American Chemical Society, Vol. 49, p. 3181 (1927). Suitable isocyanate-reactive substances include those polymeric substances having about 2 to about 4 functional groups containing active hydrogen which are capable of reacting with isocyanate such as hydroxyl and primary or secondary amino groups. The isocyanate-reactive substance may have a number average molecular weight of from about 200 to about 100,000. In another embodiment, the molecular weight is from about 500 to about 50,000. Polyester polyols, polyether polyols, polyether ester polyols and mixtures thereof may be utilized, for instance. Examples of polyester polyols are those obtained by reacting dibasic acids such as terephthalic acid, isophthalic acid, adipic acid, azaelaic acid and sebacic acid, dialkyl esters thereof and mixtures thereof with glycols such as ethylene glycol, propylene glycol, diethylene glycol, butylene glycol, neopentyl glycol, 2-methyl-1,3-propanediol, 1,6-hexanediol and mixtures thereof. Polycaprolactone polyols may also be used. Exemplary polyether polyols include those obtained by polymerizing oxirane compounds such as ethylene oxide, propylene oxide, butylene oxide, oxirane and tetrahydrofuran using water or low molecular weight polyols such as ethylene glycol, propylene glycol, trimethylol propane or glycerin as an initiator. Copolymers of oxiranes (including random, block, and end-capped copolymers) are also suitable for use.

Examples of polyether ester polyols include those obtained by reacting polyether polyols with dibasic acids such as those mentioned herein above in connection with polyester polyols. Low molecular weight polyhydroxy compounds having a number average molecular weight of less than 200 and two or more hydroxy groups per molecule may also be used in Component B conjointly with the 1,4:3,6 dianhydrohexitol(s). Suitable polyhydroxy compounds of this type include monomeric polyols such as ethylene glycol, propylene glycol, butylene glycol, hexylene glycol, neopentyl glycol, cyclohexene dimethanol, glycerin and trimethylolpropane as well as oligomers of such polyols such as diethylene glycol, dipropylene glycol, triethylene glycol, tripropylene glycol and the like.

Specific mention may be made of the following isocyanate-reactive substances suitable for use in Component B in addition to the 1,4:3,6 dianhydrohexitol(s): saturated and unsaturated glycols such as ethylene glycol or condensates of ethylene glycol, butane-1,3-diol, butane-1,4-diol, 2-butene-1,4-diol, 2-butyne-1,4-diol, propane-1,2-diol, propane-1,3-diol, neopentyl glycol, hexanediol, bishydroxymethylcyclohexane, dioxyethoxyhydroquinone, bis-glycol terephthalate, N,N′-di(2-hydroxyethyl)-succinamide, N,N′-dimethyl-N,N′-di(2-hydroxy-ethyl)succinamide, 1,4-di(2-hydroxymethyl-mercapto)-2,3,5,6-tetrachlorobenzene, 2-methylene-propane-1,3-diol, 2-methylpropane-1,3-diol, 3-pyrrolidino-1,2-propanediol, 2-methylenepentane-2,4-diol, 3-alkoxy-1,2-propanediol, 2-ethylhexane-1,3-diol, 2,2-dimethylpropane-1,3-diol, 1,5-pentanediol, 2,5-dimethyl-2,5-hexanediol, 3-phenoxy-1,2-propanediol, 3-benzyloxy-1,2-propanediol, 2,3-dimethyl-2,3-butanediol, 3-(4-methoxyphenoxy)-1,2-propanediol, and hydroxymethylbenzyl alcohol; aliphatic, cycloaliphatic, and aromatic diamines such as ethylenediamine, hexamethylenediamine, 1,4-cyclohexylenediamine, piperazine, N-methylpropylenediamine, diaminodiphenyl sulfone, diaminodiphenyl ether, diaminodiphenyldimethyl-methane, 2,4-diamino-6-phenyltriazine, isophoronediamine, dimer fatty acid diamine, diaminodiphenylmethane, aminodiphenylamine or the isomers of phenylenediamine; carbohydrazides or hydrazides of dicarboxylic acids; amino alcohols such as ethanolamine, propanolamine, butanolamine, N-methylethanolamine, N-methylisopropanolamine, diethanolamine, triethanolamine, and higher di- or tri(alkanolamines); aliphatic, cycloaliphatic, aromatic and heterocyclic mono- and diaminocarboxylic acids such as glycine, 1- and 2-alanine, 6-aminocaproic acid, 4-aminobutyric acid, the isomeric mono- and diaminobenzoic acids, and the isomeric mono- and diaminonaphthoic acids.

Component B may also comprise a hydroxy-functional natural oil or fat such as, for example, castor oil, and/or an epoxidized natural oil or fat which has been ring-opened with one or more alcohols.

Any of the polyol components discussed below in connection with the synthesis of isocyanate-functionalized polyurethane prepolymers capable of being used in Component A of the present invention may also be utilized as a coreactant in Component B in combination with the 1,4:3,6 dianhydrohexitol(s).

The following materials are especially suitable for use as constituents of Component B in combination with one or more 1,4:3,6 dianhydrohexitols: polypropylene glycol diols and triols having an equivalent weight per —OH group of from about 150 to about 400, polyester polyols based on neopentyl glycol having an equivalent weight per —OH group of from about 200 to about 600, and polyester polyols based on diethylene glycol having an equivalent weight per —OH group of from about 150 to about 400.

Component A of the present invention contains at least one compound having two or more isocyanate groups per molecule, said compound being capable of reacting with the hydroxyl groups of the 1,4:3,6 dianhydrohexitol present in Component B. The isocyanate groups may be free —NCO groups, but can also be blocked or masked —NCO groups. One particular embodiment of the invention employs one or more isocyanate-functionalized polyurethane prepolymers in Component A. In the context of the present invention, a polyurethane prepolymer is a compound such as results, for example, from the reaction of a polyol component with at least one isocyanate having a functionality of at least two. This reaction can take place without solvent or in a solvent. The term “polyurethane prepolymer” embraces not only compounds having a relatively low molecular weight, such as are formed, for example, from the reaction of a polyol with an excess of polyisocyanate, but also oligomeric or polymeric compounds. “Perfect” polyurethane prepolymers, containing a single polyol moiety capped at each end or terminus with a polyisocyanate moiety and very little, if any, free polyisocyanate monomer or oligomeric or polymeric compounds (containing two or more polyol moieties per molecule) may also be utilized.

Molecular weight figures based on polymeric compounds refer, unless otherwise indicated, to the numerical average of the molecular weight (Mₙ). The polyurethane prepolymers used in the context of the present invention generally may have a molecular weight of from 500 to 27,000, alternatively from 700 to 15,000, or alternatively from 700 to 8,000 g/mol.

Likewise embraced by the term “polyurethane prepolymers” are compounds as formed, for example, from the reaction of a trivalent or tetravalent polyol with a molar excess of diisocyanates, based on the polyol. In this case one molecule of the resultant compound bears two or more isocyanate groups.

To obtain polyurethane prepolymers having terminal isocyanate groups it is customary to react polyfunctional alcohols (polyols) with an excess of polyisocyanates, generally at least predominantly diisocyanates. In this case the molecular weight can be controlled at least approximately by way of the ratio of OH groups to isocyanate groups. While a ratio of OH groups to isocyanate groups of 1:1 or near to 1:1 often leads to substances with high molecular weights, it is the case with a ratio of approximately 2:1, for example, when using diisocyanates, that one diisocyanate molecule is attached on average to each OH group, so that in the course of the reaction, in the ideal case, there is no oligomerization or chain extension.

Excess unreacted polyisocyanate monomer may be removed from the polyurethane prepolymer reaction product initially obtained by any known method such as, for example, distillation to provide a prepolymer having a desirably low level of polyisocyanate monomer (e.g., less than 1 weight %).

Polyurethane prepolymers are customarily prepared by reacting at least one polyisocyanate, preferably a diisocyanate, and at least one component having functional groups which are reactive toward isocyanate groups, generally a polyol component, which is preferably composed of diols. The polyol component may contain only one polyol, although it is also possible to use a mixture of two or more polyols as the polyol component. By a polyol is meant a polyfunctional alcohol, i.e., a compound having more than one OH group in the molecule. By “functional groups which are reactive toward isocyanate groups” are meant, in the context of the present text, functional groups which can react with isocyanate groups to form at least one covalent bond.

Suitable reactive functional groups containing active hydrogen may be monofunctional in the sense of a reaction with isocyanates: OH groups or mercapto groups, for example. Alternatively, they may also be difunctional with respect to isocyanates: amino groups, for example. A molecule containing a primary amino group, accordingly, also has two functional groups which are reactive toward isocyanate groups. In this context it is unnecessary for a single molecule to have two separate functional groups that are reactive toward isocyanate groups. What is critical is that the molecule is able to connect with two isocyanate groups with the formation in each case of one covalent bond.

As the polyol component it is possible to use a multiplicity of polyols. These are, for example, aliphatic alcohols having from 2 to 4 OH groups per molecule. The OH groups may be both primary and secondary. Examples of suitable aliphatic alcohols include ethylene glycol, propylene glycol, butane-1,4-diol, pentane-1,5-diol, hexane-1,6-diol, heptane-1,7-diol, octane-1,8-diol and their higher homologs or isomers such as result in a formal sense from a stepwise extension of the hydrocarbon chain by one CH₂ group in each case or with the introduction of branches into the carbon chain. Likewise suitable are higher polyfunctional alcohols such as, for example, glycerol, trimethylolpropane, pentaerythritol and also oligomeric ethers of said substances with themselves or in a mixture of two or more of said ethers with one another.

As the polyol component it is additionally possible to use reaction products of low molecular weight polyfunctional alcohols with alkylene oxides, referred to as polyether polyols. The alkylene oxides have preferably 2 to 4 carbon atoms. Suitable examples are the reaction products of ethylene glycol, propylene glycol, the isomeric butanediols, hexanediols or 4,4′-dihydroxy-diphenylpropane with ethylene oxide, propylene oxide or butylene oxide, or with mixtures of two or more thereof. Also suitable, furthermore, are the reaction products of polyfunctional alcohols, such as glycerol, trimethylolethane or trimethylolpropane, pentaerythritol or sugar alcohols, or mixtures of two or more thereof, with the stated alkylene oxides to form polyether polyols. Particularly suitable polyether polyols are those having a molecular weight from about 100 to about 10,000, preferably from about 200 to about 5,000. Likewise suitable as the polyol component are polyether polyols such as are formed, for example, from the polymerization of tetrahydrofuran.

The polyethers may be synthesized using methods known to the skilled worker, by reaction of the starting compound having a reactive hydrogen atom with alkylene oxides: for example, ethylene oxide, propylene oxide, butylene oxide, styrene oxide, tetrahydrofuran or epichlorohydrin or mixtures of two or more thereof. Examples of suitable starting compounds are water, ethylene glycol, propylene 1,2-glycol or 1,3-glycol, butylene 1,4-glycol or 1,3-glycol, hexane-1,6-diol, octane-1,8-diol, neopentylglycol, 1,4-hydroxymethylcyclohexane, 2-methyl-1,3-propanediol, glycerol, trimethylolpropane, hexane-1,2,6-triol, butane-1,2,4-triol, trimethylolethane, pentaerythritol, mannitol, sorbitol, methylglycosides, sugars, phenol, isononylphenol, resorcinol, hydroquinone, 1,2,2- or 1,1,2-tris(hydroxyphenyl)ethane, ammonia, methyl amine, ethylenediamine, tetra- or hexamethyleneamine, triethanolamine, aniline, phenylenediamine, 2,4- and 2,6-diaminotoluene and polyphenylpolymethylene-polyamines, such as are obtainable by aniline-formaldehyde condensation, or mixtures of two or more thereof.

Likewise suitable for use as the polyol component are polyethers which have been modified by vinyl polymers. Products of this kind are available, for example, by polymerizing styrene or acrylonitrile, or a mixture thereof, in the presence of polyethers.

Polyester polyols having a molecular weight of from about 200 to about 10,000 are likewise suitable as the polyol component. Thus, for example, it is possible to use polyester polyols formed by reacting low molecular weight alcohols, especially ethylene glycol, diethylene glycol, neopentyl glycol, hexanediol, butanediol, propylene glycol, glycerol or trimethylolpropane, with caprolactone. Likewise suitable as polyfunctional alcohols for preparing polyester polyols are 1,4-hydroxymethylcyclohexane, 2-methyl-1,3-propanediol, butane-1,2,4-triol, tri ethylene glycol, tetraethyl ene glycol, polyethylene glycol, dipropylene glycol, polypropylene glycol, dibutylene glycol and poly-butylene glycol.

Further suitable polyester polyols are preparable by polycondensation. For instance, difunctional and/or trifunctional alcohols can be condensed with a substoichiometric amount of dicarboxylic acids and/or tricarboxylic acids, or their reactive derivatives (e.g., anhydrides, esters), to form polyester polyols. Examples of suitable dicarboxylic acids are adipic acid or succinic acid and their higher homologs having up to 16 carbon atoms, unsaturated dicarboxylic acids such as maleic acid or fumaric acid, and also aromatic dicarboxylic acids, particularly the isomeric phthalic acids, such as phthalic acid, isophthalic acid or terephthalic acid. Examples of suitable tricarboxylic acids are citric acid or trimellitic acid. These acids may be used individually or as mixtures of two or more thereof. Particularly suitable alcohols are hexanediol, ethylene glycol, 1,4-butanediol, diethylene glycol, glycerol or neopentyl glycol or mixtures of two or more thereof. To obtain hydroxyl end groups, an excess of hydroxyl equivalents relative to carboxyl equivalents is employed. Typically, hydroxyl:carboxyl equivalent ratios range from about 2:1 to about 15:14. The nearer this ratio is to unity, the higher the molecular weight of the polyester polyol will be. The extent of conversion of carboxylic acid groups (or equivalents thereof) to ester groups (as part of the polyester formed) is typically at least 99%, more preferably at least about 99.9%. Particularly suitable acids include isophthalic acid, orthophthalic acid anhydride and adipic acid and their mixtures.

Particularly suitable di- and trifunctional alcohols which can be used in combination with the hydroxyl-functionalized transesterification product include ethylene glycol, ethylene glycol oligomers (e.g., diethylene glycol), polypropylene glycol, glycerin and mixtures thereof.

Polyester polyols of high molecular weight include, for example, the reaction products of polyfunctional alcohols, preferably difunctional alcohols (together where appropriate with small amounts of trifunctional alcohols) and polyfunctional carboxylic acids, preferably difunctional carboxylic acids. Instead of free polycarboxylic acids use may also be made (if possible) of the corresponding polycarboxylic anhydrides or corresponding polycarboxylic esters with alcohols having preferably 1 to 3 carbon atoms. The polycarboxylic acids may be aliphatic, cycloaliphatic, aromatic or heterocyclic or both. They may where appropriate be substituted by alkyl groups, alkenyl groups, ether groups or halogens, for example. Examples of suitable polycarboxylic acids include succinic acid, adipic acid, suberic acid, azelaic acid, sebacic acid, phthalic acid, isophthalic acid, terephthalic acid, trimellitic acid, phthalic anhydride, tetrahydro-phthalic anhydride, hexahydrophthalic anhydride, tetrachlorophthalic anhydride, endomethylenetetrahydrophthalic anhydride, glutaric anhydride, maleic acid, maleic anhydride, fumaric acid, dimer fatty acid or trimer fatty acid or mixtures of two or more thereof. Where appropriate, minor amounts of monofunctional fatty acids may be present in the reaction mixture.

The polyesters may where appropriate contain a small fraction of carboxyl end groups. Polyesters obtainable from lactones, ε-caprolactone for example, or hydroxycarboxylic acids, co-hydroxycaproic acid for example, may likewise be used.

Polyacetals and polyester ether polyols are likewise suitable as the polyol component. By polyacetals are meant compounds obtainable from glycols reacted with aldehydes, for example, diethylene glycol or hexanediol or a mixture thereof condensed with formaldehyde. Polyacetals which can be used in the context of the invention may likewise be obtained by the polymerization of cyclic acetals.

Further suitable polyols include polycarbonates. Polycarbonates can be obtained, for example, by reacting diols, such as propylene glycol, butane-1,4-diol or hexan-1,6-diol, diethylene glycol, triethylene glycol or tetraethylene glycol, or mixtures of two or more thereof, with diaryl carbonates, for example, diphenyl carbonate, or phosgene.

Likewise suitable as the polyol component are polyacrylates which carry OH groups. These polyacrylates are obtainable, for example, by polymerizing ethylenically unsaturated monomers which carry an OH group. Monomers of this kind are obtainable, for example, by esterifying ethylenically unsaturated carboxylic acids and difunctional alcohols, the alcohol generally being present in a slight excess. Examples of ethylenically unsaturated carboxylic acids suitable for this purpose are acrylic acid, methacrylic acid, crotonic acid or maleic acid. Corresponding esters carrying OH groups are, for example, 2-hydroxyethyl acrylate, 2-hydroxyethyl methacrylate, 2-hydroxypropyl acrylate, 2-hydroxypropyl acrylate, 2-hydroxypropyl methacrylate, 3-hydroxypropyl acrylate or 3-hydroxypropylmethacrylate or mixtures of two or more thereof.

In addition to the aforedescribed polyol compounds, polyisocyanates are important building blocks of the polyurethane prepolymers which can be used in Component A of the two component laminating adhesives of the present invention. Suitable polyisocyanates include organic compounds containing two or more isocyanate (NCO) functional groups per molecule. These include polyisocyanates of the general structure O═C═N—X—N═C═O, where X is an aliphatic, alicyclic or aromatic radical, such as an aliphatic or alicyclic radical having from 4 to 18 carbon atoms. Illustrative polyisocyanates include, for example, 1,5-naphthylene diisocyanate, 4,4′-diphenylmethane diisocyanate (MDI), hydrogenated MDI (H₁₂MDI), xylylene diisocyanate (XDI), tetramethylxylylene diisocyanate (TMXDI), 4,4′-diphenyldimethyl-methane diisocyanate, di- and tetraalkylenediphenylmethane diisocyanate, 4,4′-dibenzyl diisocyanate, 1,3-phenylene diisocyanate, 1,4-phenylene diisocyanate, the isomers of tolylene diisocyanate (TDI), 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), chlorinated and brominated diisocyanates, phosphorus-containing diisocyanates, 4,4% diisocyanatophenylperfluoroethane, tetramethoxybutane 1,4-diisocyanate, butane 1,4-diisocyanate, hexane 1,6-diisocyanate (HDI), dicyclohexylmethane diisocyanate, cyclohexane 1,4-diisocyanate, ethylene diisocyanate, bisisocyanatoethyl phthalate and also diisocyanates having reactive halogen atoms, such as 1-chloromethylphenyl 2,4-diisocyanate, 1-bromomethylphenyl 2,6-diisocyanate, and 3,3-bischloromethyl ether 4,4′-diphenyl diisocyanate.

Sulfur-containing polyisocyanates are obtained, for example, by reacting 2 mol of hexamethylene diisocyanate with 1 mol of thiodiglycol or dihydroxydihexyl sulfide.

Further diisocyanates which can be used are, for example, trimethylhexamethylene diisocyanate, 1,4-diisocyanatobutane, 1,12-diisocyanatododecane and dimer fatty acid diisocyanate. Particularly suitable are the following: tetramethylene, hexamethylene, undecane, dodecamethylene, 2,2,4-trimethylhexane, 1,3-cyclohexane, 1,4-cyclohexane, 1,3- or 1,4-tetramethylxylene, isophorone, 4,4-dicyclohexylmethane and lysine ester diisocyanates.

Examples of suitable polyisocyanates having a functionality of at least three are the trimerization and oligomerization products of the polyisocyanates already mentioned above, such as are obtainable, with the formation of isocyanurate rings, by appropriate reaction of polyisocyanates, preferably of diisocyanates. Where oligomerization products are used, those particularly suitable have a degree of oligomerization of on average from about 3 to about 5.

Isocyanates suitable for the preparation of trimers are the diisocyanates already mentioned above, particular preference being given to the trimerization products of the isocyanates HDI, MDI or IPDI.

Likewise suitable for use as the polyisocyanate are the polymeric isocyanates, such as are obtained, for example, as a residue in the distillation bottoms from the distillation of diisocyanates. Polymeric MDI (PMDI), which may be obtained from the distillation residue during the distillation of MDI, is particularly suitable.

The amounts of Component A and Component B used in the laminating adhesive systems of this invention will generally be adjusted so as to provide an NCO/active hydrogen equivalent ratio in the range of from about 1 to 10 in one embodiment of the invention, from about 1.05 to about 5 in another embodiment, and from about 1.1 to about 2 in yet another embodiment. In one particularly advantageous embodiment of the invention, the NCO/OH equivalent ratio is selected to be within the range of about 1.15:1 to about 1.25:1 (e.g., about 1.18:1 to about 1.20:1). An excess of isocyanate relative to active hydrogen leads to the generation of an adhesive that is capable of being moisture cured by reaction of the isocyanate groups that remain unreacted after combining Component A and Component B, thereby forming urea groups in the cured adhesive that tend to improve the hardness and chemical and heat resistance of the adhesive. Typically, the free isocyanate content (prior to any reaction between Component A and Component B) will be from about 1% to about 25% by weight based on the total weight of the two component adhesive.

Preferably, the materials and proportions of materials used in Component A and Component B are selected so that the viscosity of the resulting mixture within the temperature range of 25 to 80 degrees C. immediately after mixing of the components is not greater than 3000 cps, more preferably not greater than 1500 cps.

Where appropriate, in addition to the isocyanate-functionalized compound(s) and active hydrogen-functionalized compound(s) previously described, the two component laminating adhesive of the invention may comprise one or more further additives. The additives may, for example, account for up to about 10% by weight of the overall two component adhesive.

The optional additives which can be used in the context of the present invention include solvents (although preferably the two component laminating adhesive is essentially or entirely free of solvent), adhesion promoters, catalysts, plasticizers, stabilizers, antioxidants, light stabilizers, fillers, dyes, pigments, fragrances, preservatives or mixtures thereof.

The film or films to be adhered to each other using the two component formulations of the present invention may be comprised of any of the materials known in the art to be suitable for use in flexible packaging, including both polymeric and metallic materials as well as paper (including treated or coated paper). Thermoplastics are particularly preferred for use as at least one of the layers. The materials chosen for individual layers in a laminate are selected to achieve specific desired combinations of properties, e.g., mechanical strength, tear resistance, elongation, puncture resistance, flexibility/stiffness, gas and water vapor permeability, oil and grease permeability, heat sealability, adhesiveness, optical properties (e.g., clear, translucent, opaque), formability, merchantability and relative cost. Individual layers may be pure polymers or blends of different polymers. The polymeric layers are often formulated with colorants, anti-slip, anti-block, and anti-static processing aids, plasticizers, lubricants, fillers, stabilizers and the like to enhance certain layer characteristics.

Particularly preferred polymers for use in the present invention include, but not limited to, polyolefins such as polyethylene (including low density polyethylene (LDPE), medium density polyethylene (MDPE), high density polyethylene (HPDE), high molecular weight, high density polyethylene (HMW-HDPE), linear low density polyethylene (LLDPE), linear medium density polyethylene (LMPE)), polypropylene (PP), oriented polypropylene, and clarified polypropylene, polyesters such as poly (ethylene terephthalate) (PET) and poly (butylene terephthalate) (PBT), ethylene-vinyl acetate copolymers (EVA), ethylene-acrylic acid copolymers (EAA), ethylene-methyl methacrylate copolymers (EMA), ethylene-methacrylic acid salts (ionomers), hydrolyzed ethylene-vinyl acetate copolymers (EVOH), polyamides (nylon), polyvinyl chloride (PVC), poly(vinylidene chloride) copolymers (PVDC), polybutylene, ethylene-propylene copolymers, polycarbonates (PC), polystyrene (PS), styrene copolymers, high impact polystyrene (HIPS), acrylonitrile-butadiene-styrene polymers (ABS), and acrylonitrile copolymers (AN).

The polymer surface may be treated or coated, if so desired. For example, a film of polymer may be metallized by depositing a thin coating of a metal such as aluminum onto the film's surface. Metallization may enhance the barrier properties of the finished laminate. A coating of an inorganic oxide such as silicon dioxide or aluminum oxide may also be present on the surface of the polymeric film. The polymer film surface may also be coated with anti-fog additive or the like or subjected to a pretreatment with electrical or corona discharges, or ozone or other chemical agents to increase its adhesive receptivity.

One or more layers of the laminate may also comprise a metal foil, such as aluminum foil, or the like. The metal foil will preferably have a thickness of about 5 to 100 μm.

The individual films comprising the laminates of the present invention can be prepared in widely varying thicknesses, for example, from about 5 to about 200 microns. The films, foils, and laminating adhesive formulation can be assembled into the laminate by using any one or more of the several conventional procedures known in the art for such purpose. For instance, the adhesive formulation may be applied to the surface of one or both of two films/foils by means of extrusion, brushes, rollers, blades, spraying or the like and the film/foil surfaces bearing the adhesive composition brought together and passed through a set of rollers (often referred to as nip rollers) which press together the film/foils having the adhesive composition between the films/foils. The resulting laminate may be rolled or wound onto a reel. The adhesive obtained by combining Components A and B may be applied by conventional techniques; e.g., by a multi-roll application station.

Typically, the rate at which the adhesive formulation is applied to the surface of a film or foil is in the range of about 0.2 to about 5 g/m². For example, the two components of the adhesive formulation may be pumped from separate drums or tanks at from about room temperature to about 40° C., mixed in the desired ratio using standard methods and equipment (for example, a meter-mix unit such as a M/M/D (Meter/Mix/Dispense) pump) and applied using solventless application machinery having the capability of being heated from about 25° C. to about 90° C. The adhesive composition of the present invention is utilized as a two component system wherein the two components are combined shortly before use. It may be desirable to heat the laminate at an elevated temperature (e.g., about 40° C. to about 100° C.) so as to accelerate full curing of the adhesive composition. Alternatively, the adhesive composition may be adjusted so as to be curable at approximately room temperature (e.g., about 20° C. to about 40° C.) over a period of from about 1 hour to about 7 days. Radiation may also be used to increase the cure rate of the adhesive.

Generally speaking, the adhesive compositions of the present invention are believed to be largely chemically cured through the reaction of the formulation constituents containing isocyanate groups and the constituents containing hydroxyl or other active hydrogen groups (e.g., the 1,4:3,6 dianhydrohexitol). However, curing can also be accomplished at least in part through moisture curing. Although sufficient moisture may be inherently present on the film or foil surfaces for this purpose, water may also be deliberately introduced through conventional methods if so desired.

Laminates prepared in accordance with the present invention may be used for packaging purposes in the same manner as conventional or known flexible laminated packaging films. The laminates are particularly suitable for forming into flexible pouch-shaped container vessels capable of being filled with a foodstuff and retorted. For example, two rectangular or square sheets of the laminate may be piled in the desired configuration or arrangement; preferably, the two layers of the two sheets which face each other are capable of being heat-sealed to each other. Three peripheral portions of the piled assembly are then heat-sealed to form the pouch. Heat-sealing can easily be accomplished by means of a heating bar, heating knife, heating wire, impulse sealer, ultrasonic sealer, or induction heating sealer.

The foodstuff is thereafter packed in the so-formed pouch. If necessary, gasses injurious to the foodstuff such as air are removed by known means such as vacuum degasification, hot packing, boiling degasification, or steam jetting or vessel deformation. The pouch opening is then sealed using heat. The packed pouch may be charged to a retorting apparatus and sterilized by heating to a temperature greater than about 100° C.

### EXAMPLES

Mixtures of the following polyols were prepared and used as coreactants in two component laminating adhesive formulations together with isocyanate-functionalized polyurethane prepolymer containing 16 weight % NCO.

### Example 1

### Invention

86 parts by weight polypropylene glycol triol having an equivalent weight of 242 per OH group/14 parts by weight isosorbide (mixture remained clear and homogeneous).

### Example 2

### Comparative

86 parts by weight polypropylene glycol triol having an equivalent weight of 242 per OH group/14 parts by weight dipropylene glycol (mixture remained clear and homogeneous).

### Example 3

### Invention

86 parts by weight neopentyl glycol-based polyester polyol having an equivalent weight of 351 per OH group/14 parts by weight isosorbide (some crystallization observed after sitting overnight at room temperature).

### Example 4

### Comparative

86 parts by weight neopentyl glycol-based polyester polyol having an equivalent weight of 351 per OH group/14 parts by weight dipropylene glycol (mixture remained clear and homogeneous).

### Example 5

### Invention

86 parts by weight diethylene glycol-based polyester polyol having an equivalent weight of 267 per OH group/14 parts by weight isosorbide (mixture remained clear and homogeneous).

### Example 6

### Comparative

86 parts by weight diethylene glycol-based polyester polyol having an equivalent weight of 267 per OH group/14 parts by weight dipropylene glycol (mixture remained clear and homogeneous).

### Example 7

### Invention

72 parts by weight polypropylene glycol triol having an equivalent weight of 242 per OH group/28 parts by weight isosorbide (mixture crystallized after two days at room temperature).

### Example 8

### Comparative

72 parts by weight polypropylene glycol triol having an equivalent weight of 242 per OH group/28 parts by weight dipropylene glycol (mixture remained clear and homogeneous).

### Example 9

### Invention

72 parts by weight diethylene glycol-based polyester polyol having an equivalent weight of 267 per OH group/28 parts by weight isosorbide (mixture remained clear and homogeneous).

### Example 10

### Comparative

72 parts by weight diethylene glycol-based polyester polyol having an equivalent weight of 267 per OH group/28 parts by weight dipropylene glycol (mixture remained clear and homogeneous).

In Examples 1-6, the laminating adhesives were prepared by combining 17 parts by weight of the polyurethane prepolymer with 10 parts by weight of the polyol coreactant mixture. In Examples 7-10, the laminating adhesives were prepared by combining 21 parts by weight of the polyurethane prepolymer with 10 parts by weight of the polyol coreactant mixture. The laminating adhesives based on Examples 1, 3 and 5 in accordance with the invention contained about 5 weight % isosorbide whereas the laminating adhesives based on comparative examples 2, 4 and 6 contained approximately the same amount by weight of dipropylene glycol. The laminating adhesives based on Examples 7 and 9 in accordance with the invention contained about 9 weight % isosorbide whereas the laminating adhesives based on comparative examples 8 and 10 contained approximately the same amount by weight of dipropylene glycol. The laminating adhesives thereby obtained were used at a coating weight of 1.2 pounds per 3000 square feet (2 g/m²) to laminate 92 gauge polyester film to 4 mil polyethylene film, with the films being nipped together with the laminating adhesive layer in between.

The results shown in Table 1 were obtained.

TABLE 1

| Polyol | | | 1 Day Bond |
|---|---|---|---|
| Coreactant | 3 Hour Bond | 1 Day Bond | Strength (at |
| Mixture | Strength, gli | Strength, gli | 70° C.), gli |
| Example 1 | 17 (peel) | 749 (PET stock tear) | 286 (stock split) |
| (Invention) | | | |
| Example 2 | 18 (peel) | 372 (stock split) | 95 (peel) |
| (Comparative) | | | |
| Example 3 | 27 (peel) | 776 (stock tear) | 536 (stock split) |
| (Invention | | | |
| Example 4 | 20 (peel) | 286 (stock split) | 272 (peel) |
| (Comparative) | | | |
| Example 5 | 54 (peel) | 1425 (stock tear) | 123 (peel) |
| (Invention) | | | |
| Example 6 | 59 (peel) | 318 (peel) | 54 (peel) |
| (Comparative) | | | |
| Example 7 | 232 (peel) | 520 (stock tear) | 1044 (stock tear) |
| (Invention) | | | |
| Example 8 | 24 (peel) | 306 (stock tear) | 613 (peel) |
| (Comparative) | | | |
| Example 9 | 69 (peel) | 573 (peel) | 1158 (stock tear) |
| (Invention) | | | |
| Example 10 | 19 (peel) | 308 (peel) | 308 (peel) |
| (Comparative) | | | |

These results demonstrate that laminating adhesives based on isosorbide as a polyol coreactant exhibit laminate bond strengths after one day of curing that are significantly higher than the laminate bond strengths obtained using laminating adhesives based on dipropylene glycol. Similar results were observed when the laminate is heated to 70° C., confirming the inherently higher strength of the isosorbide-based formulations at higher use temperatures as compared to analogous control formulations based on dipropylene glycol. This is an important advantage when the laminate is formed into a pouch to be used in a hot filling or retort application.

What is claimed is:

1. A two component laminating adhesive comprising Component A and Component B, wherein Component A comprises at least one isocyanate-functionalized compound and Component B comprises at least one 1,4:3,6 dianhydrohexitol.

2. The two component laminating adhesive of claim 1, wherein Component B is comprised of at least 5 weight percent 1,4:3,6 dianhydrohexitol.

3. The two component laminating adhesive of claim 1, wherein at least about 10 mole % of the active hydrogen groups in Component B are 1,4:3,6 dianhydrohexitol active hydrogen groups.

4. The two component laminating adhesive of claim 1, wherein Component B is additionally comprised of at least one active hydrogen-containing compound other than 1,4:3,6 dianhydrohexitols.

5. The two component laminating adhesive of claim 1, wherein Component B is additionally comprised of at least one active hydrogen-containing compound selected from the group consisting of monomeric polyols other than 1,4:3,6 dianhydrohexitols, oligomers of monomeric polyols, polyether polyols, polyetherester polyols and polyester polyols.

6. The two component laminating adhesive of claim 1, wherein Component A comprises an isocyanate-functionalized polyurethane prepolymer.

7. The two component laminating adhesive of claim 1, wherein Component B comprises isosorbide.

8. A laminate comprised of at least one polymeric film and the two component laminating adhesive of claim 1 in cured form.

9. The laminate of claim 7, wherein said laminate is comprised of at least two polymeric films and the two component laminating adhesive is located between at least two of said polymeric films and adheres said polymeric films to each other.

10. The laminate of claim 7 wherein at least one polymeric film is comprised of a thermoplastic selected from the group consisting of polyethylene terephthalate, polyethylene, polypropylene, and polyvinylidene chloride.

11. The laminate of claim 7 additionally comprising a metal foil, wherein the two component laminating adhesive is located between the metal foil and at least one polymeric film.

12. The laminate of claim 7 wherein at least one polymeric film is metallized or has a coating comprised of an inorganic oxide deposited thereon.

13. A flexible film laminate comprising
(a) a first layer comprised of a first polyolefin or first polyester;
(b) a second layer comprised of a second polyolefin, which may be the same or different from the first polyolefin, a second polyester, which may be the same as or different from the first polyester, or a metal foil;
(c) an adhesive layer bonding the first layer to the second layer, said adhesive layer being obtained by combining and reacting Component A and Component B in accordance with the two component laminating adhesive of claim 1.

14. A method of making a flexible film laminate, said method comprising a) combining Component A and Component B in accordance with the two component laminating adhesive of claim 1 to form an adhesive mixture, b) joining a first flexible film and a second flexible film using the adhesive mixture interposed between the first flexible film and the second flexible film, and c) curing the adhesive mixture.
